(19) United States
(12) Patent Application Publication
(10) Pub. No.: US 2003/0229573 A1
(43) Pub. Date: Dec. 11, 2003

(54) Yacht Ownership and vacation program

(76) Inventor: Sean O. Southland, Scottsdale, AZ (US)

Correspondence Address: C. Robert von Hellens, CAHILL, VON HELLENS & GLAZER P.L.C., Suite 155, 2141 E. Highland Avenue, Phoenix, AZ, 85016, US

(21) Appl. No.: 10/295,529

(22) Filed: Nov. 15, 2002

Related U.S. Application Data
(60) Provisional application No. 60/386,060, filed on Jun. 5, 2002.

(51) Int. Cl. G06F 17/60

(52) U.S. Cl. 705/37

(57) ABSTRACT

A yacht ownership and vacation program is based on multi-year yacht resort timesharing leasehold at top vacation locations in the world and having the highest tourist value year around. Each yacht resort is part of a chain of ultra-inclusive, resort style, luxurious mega yachts based at ports around the world. A customer enjoys a vacation stay for a specified period or uses the ownership as an investment for family, friends and the future. The program allows for the rental, exchange, resale and banking of one or more weeks at each port. The program may also be used for corporate retreats or as a second residence. By selling a maximum of 75% of the weeks of a year to the customers and maintaining the remaining weeks available for exchanges between customers, the program virtually guarantees availability of a yacht resort at a port of choice.

### CROSS-REFERENCE TO RELATED APPLICATIONS

The present application is related to and claims priority of a provisional application entitled “An Exclusive Yacht Ownership Program”, filed Jun. 5, 2002, and assigned Serial No. 60/386,060.

### BACKGROUND OF THE INVENTION

1. Field of the Invention

This invention relates generally to allocating resources and scheduling, and more particularly to methods of selling leaseholds of yachts for intervals of time, including vacation packages related thereto.

2. Description of the Related Art

It is well known to sell time-share units of structures such as apartment-style buildings located at a single, fixed location. Typically, a customer buys a right to occupy and use an apartment, or similar space, for a predetermined duration of time per year, such as one week per year. U.S. Patent Application Publication No. US 2002/0077874A1, published Jun. 20, 2002, entitled “Methods and Systems for Time Sharing on Cruise Ships”, by Dakin, filed Dec. 15, 2000, is a method and system for implementing a time sharing arrangement for cabins on a cruise ship.

Some prior art time sharing arrangements have a provision for an owner of a time sharing interval to switch to another interval if such other interval is available. In known prior art methods and systems, this desirable provision is disadvantageously not readily available because most, if not all, available intervals are previously sold. As a result, the only way an owner can change intervals is to trade with another owner, if such other owner would be willing to make such trade.

Thus, what is needed is a method that would make other intervals more readily available, and a method that would avoid requiring an owner of one interval to have to find another owner of a different interval with whom to trade.

### SUMMARY OF THE INVENTION

The present invention provides a method of selling fractional leaseholds of a yacht, which includes the steps of: dividing use of the yacht into a plurality of intervals of time per year, a sum of the plurality of intervals of time into which the yacht is divided being 100% of a total available time of the yacht per year; selling use of the yacht during one or more fractional leasehold intervals of time per year for a plurality of years, a total of the fractional leasehold intervals of time being less than 100% of the sum; and maintaining an inventory of intervals of time not sold as fractional leaseholds.

The present invention also provides a method of selling fractional leaseholds of at least two yachts, each yacht of the at least two yachts being located at a different port, which includes the steps, for each yacht, of: dividing use of the yacht into a plurality of intervals of time, a sum of the plurality of intervals of time into which the yacht is divided being 100% of a total available time of the yacht; selling use of the yacht during one or more fractional leasehold intervals of time per year for a plurality of years, a total of the fractional leasehold intervals of time being less than 100% of the sum; and maintaining an inventory of intervals of time not sold as fractional leaseholds.

The present invention further provides a method of selling fractional leaseholds of a yacht, which includes the steps of: positioning the yacht at a first port; dividing use of the yacht into a plurality of intervals of time per year, a sum of the plurality of intervals of time into which the yacht is divided being 100% of a total available time of the yacht per year; selling use of the yacht during one or more fractional leasehold intervals of time per year for a plurality of years, a total of the fractional leasehold intervals of time being less than 100% of the sum; maintaining an inventory of intervals of time not sold as fractional leaseholds; and repositioning the yacht at a second port, remote from the first port, in response to changing conditions at the first port relative to the second port, while maintaining ownerships of the fractional leaseholds in the yacht unchanged.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates a simplified flow diagram showing a method of selling timesharing fractional leaseholds on a yacht in accordance with the invention.

### DESCRIPTION OF THE PREFERRED EMBODIMENT

A yacht ownership program is based on multi-year cooperative timesharing property leasehold. A lessor owns or otherwise controls, at least one yacht. Preferably, the yacht is a luxurious large, or mega, yacht. Preferably, the yacht is about 65-100 feet in length. The yacht is positioned, or docked, at a port at a desirable resort location. The lessor sells use of the yacht for a certain period of time per year for a term of years. Typically, a potential customer is a person who wants to take vacations on the yacht; alternatively, the potential customer is a corporation or other group that wants use of the yacht for its members, customers or employees. The lessor also supplies goods and services associated with a luxurious vacation. Preferably, the lessor supplies all the goods and services that a person on vacation would need or desire, i.e., ultra-inclusive. The yacht in combination with the other goods and services forms a yacht resort based at a predetermined port, but movable therefrom in accordance with the desires of each individual customer. A plurality of such yacht resorts become a chain of ultra-inclusive, resort style, mega yachts based at ports around the world.

Prior to leasing any time on a yacht, the lessor divides an entire year's use of the yacht into a number of intervals of time, hereinafter “intervals”. Then, the lessor offers for sale to customers use of the yacht during one or more of the intervals. The intervals are offered as fractional leasehold intervals on a first-come, first-served basis, and the customer chooses one or more intervals from among the intervals that have not been sold to other customers. Upon entering into a written agreement with the lessor, the customer becomes a leasehold owner for one or more of the intervals. The term of the written agreement is for more than one year; preferably, the term is fifteen years.

The lessor sells to a customer use of the yacht during one or more fractional leasehold intervals per year for a plurality of years; however, the lessee does not sell all the intervals as fractional leaseholds; preferably, the lessee sells less than 75% of the intervals as fractional leaseholds. The lessor maintains an inventory of intervals not sold as fractional leaseholds. Preferably, the intervals not sold as fractional leaseholds comprise at least 25% of the number of intervals. Advantageously, the program provides for availability of an interval by dividing leasehold ownership among customers at a maximum of 75% of the total number of intervals. A remaining 25% of the intervals are thereby readily made available for fellow customer exchanges. Alternatively, some of the remaining 25% intervals can be used for travel agency reservations for one-time sales. This method allows the lessor to offer use of the yacht to a customer during one of the remaining 25% intervals not sold as a fractional leasehold, in exchange for the interval purchased by the customer.

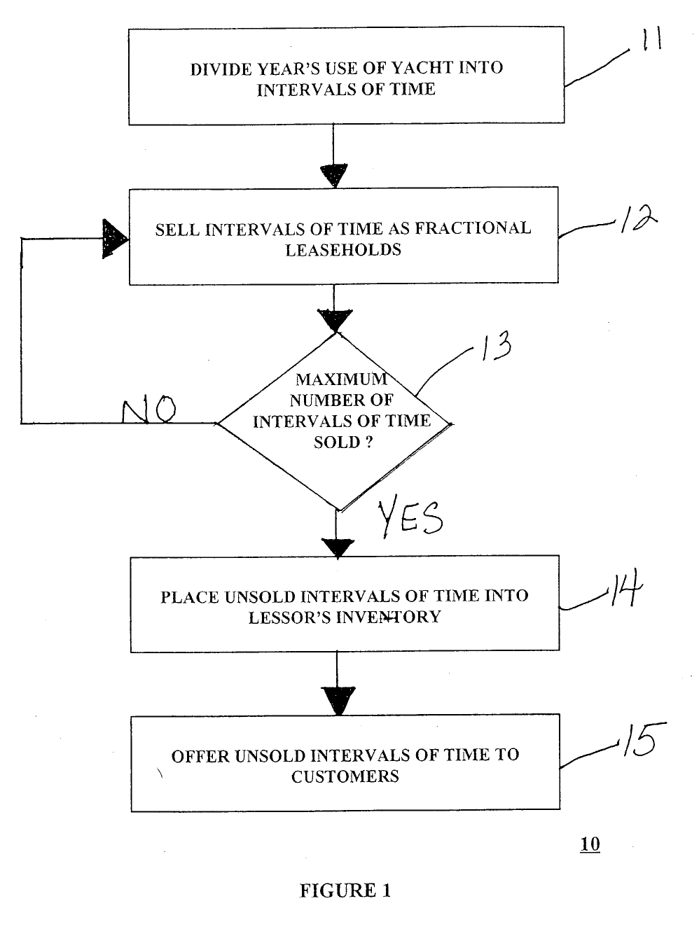

FIG. 1 is a simplified flow diagram 10 showing a method of selling fractional leaseholds on yachts in accordance with the invention. First, a year's use of each yacht is divided into a plurality of intervals, step 11. The intervals are sold as fractional leaseholds, step 12. A determination is made at step 13 whether a maximum number of intervals have been sold. If the maximum has not been reached, more intervals are sold, step 12. If the maximum has been reached, then the unsold intervals are placed into lessor's inventory, step 14. Then, at step 15, the intervals not sold as fractional leaseholds are offered to customers for exchanging. Advantageously, this method also avoids the inconvenience of requiring an owner of one interval to find another owner of a different interval with whom to trade. Rather, a customer who wants to trade knows that the lessor has an inventory of intervals and can deal directly with the lessor. This method also allows the lessor to avoid having to find, on behalf of a first customer, a second customer who is willing to trade with the first customer.

The lessor will have at least two yachts each at a different port, which will allow the lessor to offer to a customer an interval not sold as a fractional leasehold on one yacht at one port, in exchange for the fractional leasehold interval that was purchased by the customer on another yacht at another port.

A customer enjoys a vacation stay during a specified time, or uses the ownership as an investment for family, friends and the future. For a preselected period of time chosen by the customer, each customer uses a luxurious mega yacht with ultra-inclusive accommodations available at each port. The program allows for the rental, exchange, resale and banking of weeks at each port. The program may also be used for a corporate retreat or as a second residence. Each port is one of the top vacation locations in the world and has the highest tourist value year around.

Each yacht is accompanied by a fully outfitted sister ship that is available for the customer's use. By “sister ship”, it is meant a motor-powered boat smaller than the yacht that can be used by the customer for traveling away from the yacht to visit locations of interest or for sporting activities. Each sister ship is supplied with equipment for sport fishing, scuba and snorkel expeditions, island exploring, visits to secluded beaches, Jet skiing, etc. Each sister ship includes an ultra-inclusive day spa. The sister ship is a blend of convenience and luxury. Preferably, the sister ship is approximately forty feet in length, and is equipped with powerful, dependable, twin-engine propulsion. The sister ship has full electronics, including radar and receivers for signals from global positioning satellites. The sister ship has a swim platform, a comfortable interior, and spacious decks for sunning, lounging, and other activities.

The customers chose what they want to do during their stay aboard the yacht, and the lessor provides each of the services desired, or causes others to provide the desired services. The lessor provides to the customers luxury resort-style, ultra-inclusive accommodations both on and off the yacht. The lessor submits a biographical profile questionnaire to the customers to facilitate providing luxury resort-style, ultra-inclusive accommodations commensurate with the wishes of the customers. By completing the questionnaire and returning it to the lessor, the customers thereby advise the lessor of their desires for entertainment, nightlife, sports (both afloat and offshore), sightseeing, dining, etc. The lessor works with the customer to create a personal itinerary, and makes sure that the arrangements and details are met. A yacht director serves the needs of the customer beginning when the customer arrives at the port, and the yacht director assists with any last minute changes and wishes.

Unlike cruises and luxury resort packages, which have become commonplace, the yacht leasehold ownership program in accordance with the invention gives a customer an aura of exclusivity and individual attention no longer felt at those other vacation venues.

While the invention has been described with references to several particular embodiments thereof, those skilled in the art will be able to make the various modifications to the described embodiments of the invention without departing from the true spirit and scope of the invention. It is intended that all combinations of elements and steps which perform substantially the same function in substantially the same way to achieve the same result are within the scope of the invention.

I claim:

1. A method of selling fractional leaseholds of a yacht, comprising the steps of:
a) dividing use of the yacht into a plurality of intervals of time per year, a sum of the plurality of intervals of time into which the yacht is divided being 100% of a total available time of the yacht per year;
b) selling, to customers, use of the yacht during one or more fractional leasehold intervals of time per year for a plurality of years, a total of the fractional leasehold intervals of time being less than 100% of the sum; and
c) maintaining an inventory of intervals of time not sold as fractional leaseholds.

2. The method as set forth in claim 1, wherein the total of the fractional leasehold intervals of time is approximately 75% of the sum, and in which the total of the intervals of time not sold as fractional leaseholds is approximately 25% of the sum.

3. The method as set forth in claim 1, including the step of offering, for at least one year of the plurality of years, use of the yacht to at least one of the customers one or more of the intervals of time not sold as fractional leaseholds, in exchange for one or more of the fractional leasehold intervals of time purchased by the at least one of the customers.

4. The method as set forth in claim 1, including the step of providing luxury resort-style, ultra-inclusive accommodations aboard the yacht.

5. The method as set forth in claim 4, in which the step of providing includes providing luxury resort-style, ultra-inclusive accommodations off the yacht.

6. The method as set forth in claim 5, including the step of submitting a biographical profile questionnaire to the customers to facilitate said step of providing.

7. The method as set forth in claim 1, including the step of providing use of a boat for traveling away from the yacht.

8. A method of selling fractional leaseholds of at least two yachts, each yacht of the at least two yachts being located at a different port comprising, for each yacht, the steps of:
a) dividing use of the yacht into a plurality of intervals of time per year, a sum of the plurality of intervals of time into which the yacht is divided being 100% of a total available time of the yacht per year;
b) selling to customers use of the yacht during one or more fractional leasehold intervals of time per year for a plurality of years, a total of the fractional leasehold intervals of time being less than 100% of the sum; and
c) maintaining an inventory of intervals of time not sold as fractional leaseholds.

9. The method as set forth in claim 8, wherein the total of the fractional leasehold intervals of time is approximately 75% of the sum, and wherein the total of the intervals of time not sold as fractional leaseholds is approximately 25% of the sum.

10. The method as set forth in claim 8, including the step of offering, to at least one of the customers an interval of time not sold as a fractional leasehold on one yacht of the at least two yachts, in exchange for the fractional leasehold interval of time that was purchased by the at least one of the customers on another yacht of the at least two yachts.

11. The method as set forth in claim 8, including the step of providing luxury resort-style, ultra-inclusive accommodations aboard the respective one of each of the yachts.

12. The method as set forth in claim 11, wherein the step of providing includes providing luxury resort-style, ultra-inclusive accommodations off the respective one of each of the yachts.

13. The method as set forth in claim 12, including the step of submitting a biographical profile questionnaire to each of the customers to facilitate said step of providing.

14. The method as set forth in claim 8, including the step of providing use of a boat for traveling away from the respective one of each of the yachts.

15. A method of selling fractional leaseholds of a yacht, comprising the steps of:
a) positioning the yacht at a first port;
b) dividing use of the yacht into a plurality of intervals of time per year, a sum of the plurality of intervals of time into which the yacht is divided being 100% of a total available time of the yacht per year;
c) selling use of the yacht during one or more fractional leasehold intervals of time per year for a plurality of years, a total of the fractional leasehold intervals of time being less than 100% of the sum;
d) maintaining an inventory of intervals of time not sold as fractional leaseholds; and
e) repositioning the yacht at a second port, remote from the first port, in response to changing conditions at the first port relative to the second port, while maintaining ownerships of the fractional leaseholds in the yacht unchanged.

16. The method as set forth in claim 15, wherein the total of the fractional leasehold intervals of time is approximately 75% of the sum, and wherein the total of the intervals of time not sold as fractional leaseholds is approximately 25% of the sum.

17. The method as set forth in claim 15, wherein the total of the fractional leasehold intervals of time is no more than 75% of the sum, and wherein the total of the intervals of time not sold as fractional leaseholds is no less than 25% of the sum.

18. The method as set forth in claim 15, including the step of offering, for at least one year of the plurality of years, use of the yacht to at least one of the customers one or more of the intervals of time not sold as fractional leaseholds, in exchange for one or more of the fractional leasehold intervals of time purchased by the at least one of the customers.

19. The method as set forth in claim 15, including the step of providing luxury resort-style, ultra-inclusive accommodations both aboard the yacht and off the yacht.

20. The method as set forth in claim 19, including the step of submitting a biographical profile questionnaire to each of the customers to facilitate said step of providing.
